(19) United States
(12) Patent Application Publication
(10) Pub. No.: US 2020/0343565 A1
(43) Pub. Date: Oct. 29, 2020

(54) SEPARATOR ASSEMBLY FOR FUEL CELL AND FUEL CELL STACK INCLUDING SAME

(71) Applicants: Hyundai Motor Company, Seoul (KR); Kia Motors Corporation, Seoul (KR)

(72) Inventors: Yil Hoon Yl, Busan (KR); Byeong-Heon Jeong, Seoul (KR)

(21) Appl. No.: 16/574,694

(22) Filed: Sep. 18, 2019

(30) Foreign Application Priority Data
Apr. 24, 2019 (KR) 10-2019-0048098

(51) Int. Cl. H01M 8/0247; H01M 8/0228; H01M 8/0258

(52) U.S. Cl. CPC H01M 8/0247; H01M 8/0258; H01M 8/0228

(57) ABSTRACT

A separator assembly for a fuel cell is configured such that separators made of metal materials having different thermal expansion coefficients are joined together and includes: a first separator having a first buffer portion formed by depressing at least one point on a surface of the first separator; and a second separator integrated with the first separator by joining, and having a second buffer portion that is formed by depressing a surface of the second separator such that the second buffer portion is spaced apart from the first buffer portion and surrounds the first buffer portion.

### CROSS REFERENCE TO RELATED APPLICATION

The present application claims under 35 U.S.C. § 119(a) the benefit of Korean Patent Application No. 10-2019-0048098, filed Apr. 24, 2019, the entire contents of which are incorporated by reference herein.

### BACKGROUND

### (a) Technical Field

The present disclosure relates to a separator assembly for a fuel cell and a fuel cell stack including the same, more particularly, to the separator assembly capable of stably maintaining a fixed state of separators that have different thermal expansion coefficients and thus have different thermal expansion amounts in response to temperature changes, thus maintaining an airtight state of the separators.

### (b) Description of the Related Art

A fuel cell is a known type of power generator that converts chemical energy of fuel into electric energy through an electrochemical reaction in a stack. Fuel cells have a wide range of applications, including serving as industrial power generators, serving as household power generators, powering vehicles, and powering small electronic devices such as portable devices. In recent years, fuel cells have increasingly been used as clean energy sources of high efficiency.

FIG. 1 (RELAIED ART) is a view showing a configuration of a typical fuel cell stack.

As shown in FIG. 1, in a unit cell of a typical fuel cell stack, a membrane electrode assembly (MEA) 10 is located at the innermost portion of the cell. The MEA 10 includes a polymer electrolyte membrane (PEM) 11 allowing transport of positively charged hydrogen ions (protons) therethrough, and catalyst layers (CLs), that is, an anode 12 and a cathode 13, applied on opposite surfaces of the PEM 11 to cause hydrogen and oxygen to react.

Further, a pair of gas diffusion layers (GDLs) 20 are laminated outside of the MEA 10 where the anode 12 and the cathode 13 are located. A pair of separators 30, each having a flow field for supplying fuel and discharging water generated by reactions in the MEA 10, are respectively located outside of the GDLs 20 with gaskets 40 interposed therebetween. End plates 50 are assembled at the outermost sides of the fuel cell stack to structurally support and secure individual components described above in position.

Herein, the pair of separator separators 30 may be divided into an anode separator 31 positioned on the anode, and a cathode separator 32 positioned on the cathode.

Meanwhile, a fuel cell stack is formed in a series arrangement of stacked multiple unit cells. Herein, the unit cells are stacked on top of each other such that an anode separator 31 of one of the unit cells and a cathode separator 32 of an adjacent one are arranged to face each other.

Accordingly, in order to efficiently perform a stacking process of the unit cells and to maintain a degree of alignment of the respective unit cells, stacking of the unit cells is performed by employing an integrated structure of the anode separator and the cathode separator of the adjacent unit cells, which are arranged to face each other.

FIG. 2 (RELATED ART) is a view showing separators integrated by welding according to the related art.

As shown in FIG. 2, each of the separators according to the related art has a reaction surface 35 provided at the center thereof in which an MEA is disposed, and multiple inlet manifolds 33 and multiple outlet manifolds 34 that are provided at opposite sides of the reaction surface 35, respectively. To seal the reaction surface 35, the inlet manifolds 33, and the outlet manifolds 34, a gasket 40 is used to surround a region where the reaction surface 35, the inlet manifolds 33, and the outlet manifolds 34 are provided.

A typical method of integrating an anode separator 31 and a cathode separator 32 of adjacent unit cells is to utilize spot welding, i.e., to spot weld predetermined points in edge regions of the anode and cathode separators 31 and 32 which face each other. In particular, a point to be welded is indicated by a welding spot W.

The separators 30 are generally made of 300 series stainless steel. However, in recent years, in order to suppress corrosion of the separators 30 due to water generated during operation of the fuel cell stack, the cathode separator 32, which is relatively exposed to the generated water, is made of a metal material having excellent corrosion resistance, for example, 400 series stainless steel.

When the anode separator 31 and the cathode separator 32 are made of different metal materials and then welded together as described above, a corrosion resistance performance is improved during operation of the fuel cell stack. However, there is a problem in that the anode separator 31 and the cathode separator 32, which face each other, may undergo undesired bending deformation due to temperature changes during operation of the fuel cell stack.

FIGS. 3A to 3C (RELATED ART) are views showing a behavior of the separators integrated by welding according to the related art, which is generated during operation of the fuel cell stack. As shown in FIG. 3A, the anode separator 31 and the cathode separator 32 are integrated at a welding spot W at a predetermined point in the edge regions thereof, that is, a predetermined point outside a region sealed by the gasket, for stacking of the unit cells. FIG. 3A shows a separator assembly located close to an end plate 50 that is most affected by temperature.

The fuel cell stack, which is formed by stacking the multiple unit cells each including the anode separator 31 and the cathode separator 32, has a high-temperature environment during operation and has a room-temperature environment upon operation termination while having a low-temperature environment during winter operation.

Under an environment where the ambient temperature of the fuel cell stack is raised depending on whether the fuel cell stack is operated and depending on a change in ambient environment, as shown in FIG. 3B, the anode separator 31 expands more than the cathode separator 32 in a state where the predetermined point is fixed at the welding spot W due to the difference in thermal expansion coefficient of the metal materials constituting the anode and cathode separators 31 and 32. Due to this, the anode and cathode separators 31 and 32 undergo undesired bending deformation in a direction of the cathode separator 32 made of a metal material having a relatively small thermal expansion coefficient.

On the contrary, under an environment where the ambient temperature of the fuel cell stack is lowered depending on whether the fuel cell stack is operated and depending on a change in ambient environment, as shown in FIG. 3C, the anode separator 31 contracts more than the cathode separator 32 due to the difference in thermal expansion coefficient of the metal materials constituting the anode and cathode separators 31 and 32. Due to this, the anode and cathode separators 31 and 32 undergo undesired bending deformation in a direction of the anode separator 31 made of a metal material having a relatively larger thermal expansion coefficient.

When the anode and cathode separators 31 and 32 are deformed as described above, sealing by the gasket 40 interposed between the anode separator 31, the cathode separator 32, and the end plate 50 is released, leading to leaks of reactive gas and coolant.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure provides a separator assembly for a fuel cell and a fuel cell stack including the same, the separator assembly being capable of stably maintaining a fixed state of separators that have different thermal expansion coefficients and thus have different thermal expansion amounts in response to temperature changes, thus maintaining an airtight state of the separators.

In order to achieve the above objective, according to one aspect of the present disclosure, there is provided a separator assembly for a fuel cell according to an embodiment of the present disclosure is configured such that separators made of metal materials having different thermal expansion coefficients are joined together and includes: a first separator having a first buffer portion formed by depressing at least one point on a surface of the first separator; and a second separator integrated with the first separator by joining, and having a second buffer portion that is formed by depressing a surface of the second separator such that the second buffer portion is spaced apart from the first buffer portion and surrounds the first buffer portion.

The first separator may have a larger thermal expansion coefficient than the second separator.

Each of the first separator and the second separator may include multiple manifolds provided at locations corresponding to each other and through which reactive gas and coolant are introduced and discharged, a welding spot where the first separator and the second separator are welded together may be provided at a predetermined point in each of edge regions of the first separator and the second separator, and each of the first buffer portion and the second buffer portion may be provided in a region between the manifolds and the welding spot.

A width w1 of the first buffer portion may be smaller than a width w2 of the second buffer portion.

The width w1 of the first buffer portion and the width w2 of the second buffer portion may satisfy the following Equation 1.

w2−w1 [symbol] x1−x2 Equation 1

Herein, x1 may denote an amount of expansion of the first separator in response to temperature, and x2 may denote an amount of expansion of the second separator in response to temperature.

A depth h1 of the first buffer portion may be smaller than a depth h2 of the second buffer portion.

The first buffer portion and the second buffer portion may be provided in a dot shape.

The second buffer portion may be provided in a shape of one dot, and the first buffer portion may be provided in a shape of at least one dot.

The first buffer portion and the second buffer portion may be provided in a line shape.

According to another aspect of the present disclosure, there is provided a fuel cell stack provided by stacking multiple unit cells in which each of the unit cells includes a membrane electrode assembly, a pair of gas diffusion layers, a first separator, and a second separator, wherein the first and second separators facing each other in adjacent unit cells are integrated by joining, the first separator includes a first buffer portion formed by depressing at least one point on a surface of the first separator, and the second separator includes a second buffer portion formed by depressing a surface of the second separator such that the second buffer portion is spaced apart from the first buffer portion and surrounds the first buffer portion.

According to the embodiments of the present disclosure, the anode separator and the cathode separator, which are made of metal materials having different thermal expansion coefficients, are provided with the buffer portions for compensating for expansion and contraction deformation due to temperature changes. Therefore, even when the separators expand and contract at different ratios in response to whether the fuel cell is operated and in response to a change in ambient environment, it is possible for the buffer portions to compensate such deformation of the separators, thus maintaining airtightness between the separators.

Further, due to the fact that the amount of deformation of the separators in response to temperature changes can be compensated, it is possible to prevent undesired bending deformation of the separators, thus improving structural stability of the fuel cell stack.

Further, the buffer portion of the anode separator and the buffer portion of the cathode separator are provided at locations corresponding to each other. Therefore, it is possible to improve the degree of welding alignment upon welding of the anode separator and the cathode separator, thus reducing occurrence of defective stacking.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 (RELAIED ART) is a view showing a configuration of a typical fuel cell stack;

FIG. 2 (RELATED ART) is a view showing separators integrated by welding according to the related art;

FIGS. 3A to 3C (RELATED ART) are views showing a behavior of the separators integrated by welding according to the related art, which is generated during operation of a fuel cell stack;

FIG. 4 is a view showing a separator assembly for a fuel cell according to an embodiment of the present disclosure;

FIG. 5 is a sectional view taken along line A-A of FIG. 4;

FIG. 6 is a view showing a behavior of the separator assembly for the fuel cell according to the embodiment of the present disclosure, which is generated during operation of a fuel cell stack;

FIG. 7 is a view showing a modification of the separator assembly for the fuel cell according to the embodiment of the present disclosure; and

FIGS. 8 to 10 are views showing a separator assembly for a fuel cell according to other embodiments of the present disclosure.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-of”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinbelow, exemplary embodiments of the present disclosure will be described in detail with reference to the accompanying drawings. However, it should be understood that the embodiments of the present disclosure may be changed to a variety of embodiments and the scope and spirit of the present disclosure are not limited to the embodiment described hereinbelow. The embodiments of the present disclosure described hereinbelow are provided for allowing those skilled in the art to more clearly comprehend the present disclosure. Throughout the drawings, the same reference numerals will refer to the same or like parts.

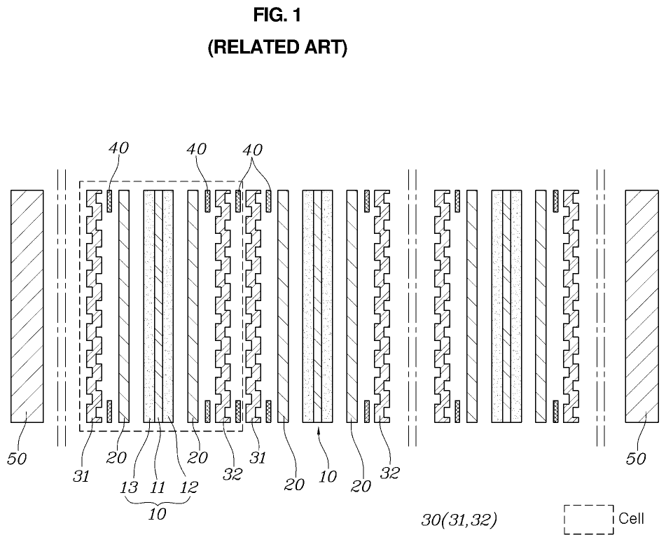

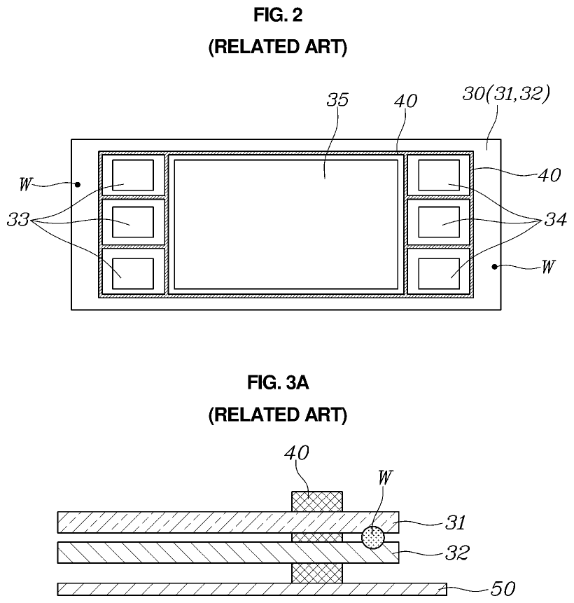

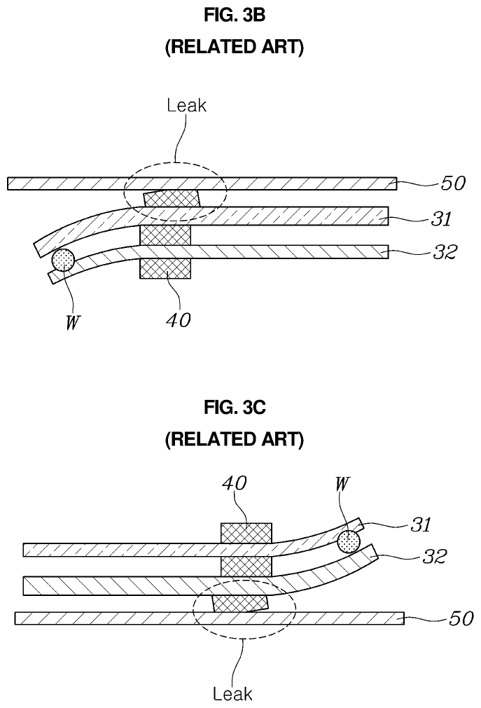

A fuel cell stack according to an embodiment of the present disclosure is to improve the airtightness by improving the shape and airtightness structure of separators while maintaining the structure of a fuel cell stack according to the related art shown in FIG. 1. In particular, in the case where separators facing each other in adjacent unit cells are made of different metal materials having different thermal expansion coefficients, even when the respective separators expand and contract at different ratios in response to temperature changes, such deformation can be absorbed, thus preventing undesired bending deformation of a pair of separators that are integrated by welding.

Therefore, a fuel cell stack according to an embodiment of the present disclosure is formed by stacking multiple unit cells to be connected in series as shown in FIG. 1. Each of the unit cells includes a membrane electrode assembly (MEA) 10, a pair of gas diffusion layers 20, an anode separator, and a cathode separator. Therefore, an anode separator provided in one cell is disposed facing a cathode separator provided in an adjacent cell. In this embodiment, the anode separator and the cathode separator which are opposed to each other are integrated by joining, thus forming a separator assembly.

In the present disclosure, when the separator assembly is made of metal materials having different thermal expansion coefficients, positions thereof are not specified as the anode separator and the cathode separator depending on the thermal expansion coefficients.

Therefore, in the following description, a separator having a relatively larger thermal expansion coefficient is referred to as a first separator, and a separator having a relatively smaller thermal expansion coefficient is referred to as a second separator in the pair of separators constituting the separator assembly.

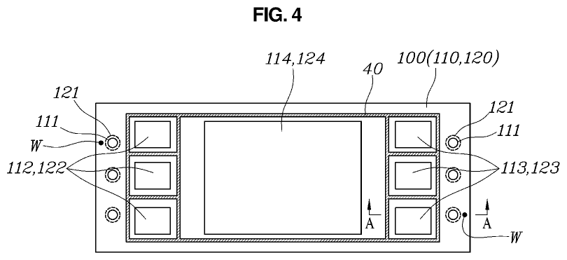

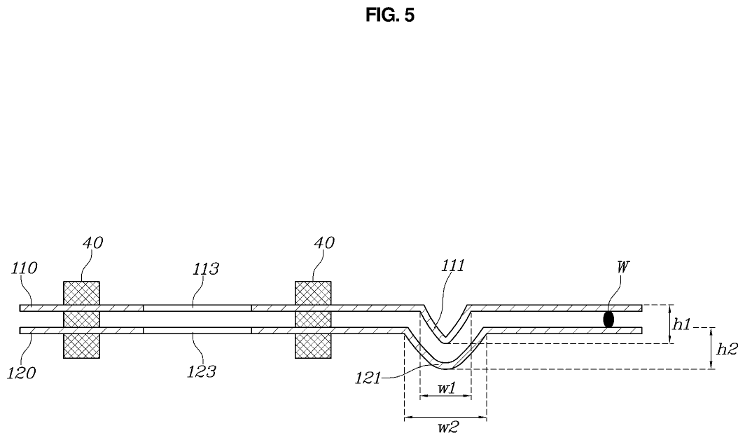

The separator assembly will be described in detail. FIG. 4 is a view showing a separator assembly for a fuel cell according to an embodiment of the present disclosure, and FIG. 5 is a sectional view taken along line A-A of FIG. 4.

As shown in FIGS. 4 and 5, the separator assembly for the fuel cell according to the embodiment of the present embodiment is a separator assembly in which a pair of separators made of metal materials having different thermal expansion coefficients are joined together. The pair of separators can be divided into a first separator 110 having a relatively larger thermal expansion coefficient and a second separator 120 having a relatively smaller thermal expansion coefficient.

The first separator 110 has a reaction surface 114 provided at the center thereof in which an MEA is disposed, and multiple inlet manifolds 112 and multiple outlet manifolds 113 that are provided at opposite side of the reaction surface 114, respectively. In order to seal the reaction surface 114, the inlet manifolds 112, and the outlet manifolds 113, a gasket 40 is used to surround a region where the reaction surface 114, the inlet manifolds 112, and the outlet manifolds 113 are provided.

Further, similar to the first separator 110, the second separator 120 also has a reaction surface 124 provided at the center thereof in which an MEA is disposed, and multiple inlet manifolds 122 and multiple outlet manifolds 123 that are provided at opposite side of the reaction surface 124, respectively. In order to seal the reaction surface 124, the inlet manifolds 122, and the outlet manifolds 123, a gasket 40 is used to surround a region where the reaction surface 124, the inlet manifolds 122, and the outlet manifolds 123 are provided.

The positions of the reaction surface 114, the inlet manifolds 112, and the outlet manifolds 113 of the first separator 110 respectively correspond to the positions of the reaction surface 124, the inlet manifolds 122, and the outlet manifolds 123 of the second separator 120.

Further, a welding spot W where the first separator 110 and the second separator 120 are joined together is provided at a predetermined point in each of edge regions of the first separator 110 and the second separator 120. The first separator 110 and the second separator 120 are integrally joined together at the welding spots W.

Meanwhile, the first separator 110 has a first buffer portion 111 that is formed by depressing at least one point on the surface of the first separator so as to absorb deformation of the first separator 110 upon expansion and contraction due to thermal changes.

Further, the second separator 120 also has a second buffer portion 121 that is formed by depressing at least one point on the surface of the second separator so as to absorb deformation of the second separator 120 upon expansion and contraction due to thermal changes. As shown in FIG. 5, the second buffer portion 121 of the second separator 120 is formed to surround the first buffer portion 111 of the first separator 110 at a location spaced apart from the first buffer portion 111.

Therefore, when the first separator 110 and the second separator 120 are deformed in response to temperature changes, such deformation of the first and second separators 110 and 120 is absorbed by the first and second buffer portions 111 and 121.

The first and second separators 110 and 120 are configured such that positions of the welding spots W and the gaskets 40 are fixed. Due to this, when the first separator 110 and the second separator 120 are deformed in response to temperature changes, the first and second separators having different thermal expansion coefficients may differ from each other in amount of deformation in a region between the gasket 40 surrounding the inlet manifolds 112 and 122 and an inlet-side welding spot W and in a region between the gasket 140 surrounding the outlet manifolds 113 and 123 and am outlet-side welding spot W, and thus the separators may undergo undesired bending deformation. In order to prevent this, it is preferable that the first buffer portion 111 and the second buffer portion 121 are provided in a region between the inlet manifolds 112 and 122 and the inlet-side welding spot W and in a region between the outlet manifolds 113 and 123 and the outlet-side welding spot W, respectively.

Meanwhile, due to the fact that the first separator 110 and second separator 120 differ from each other in amount of deformation in response to temperature changes, the first buffer portion 111 and the second buffer portion 121 may be formed to have different sizes such that a difference in the amount of deformation is compensated.

For example, as shown in FIG. 5, it is preferable that a width w1 of the first buffer portion 111 is smaller than a width w2 of the second buffer portion 121. Further, it is preferable that a depth h1 of the first buffer portion 111 is smaller than a depth h2 of the second buffer portion 121.

Therefore, when the first separator 110 and the second separator 120 expand and contract in response to temperature changes, deformation of the first buffer portion 111 is allowed inside the second buffer portion 121. This makes it possible to prevent undesired bending deformation of the first separator 110 and the second separator 120.

In particular, it is preferable that the relationship between the width w1 of the first buffer portion 111 and the width w2 of the second buffer portion 121 satisfies the following Equation 1.

w2−w1>x1−x2 Equation 1

Herein, x1 denotes the amount of expansion of the first separator 110 in response to temperature, and x2 denotes the amount of expansion of the second separator 120 in response to temperature.

For example, when a difference in thermal expansion coefficient between the first separator 110 and the second separator 120 is 1.6 times, and when x1 within an operating temperature range of a fuel cell is 16 mm, x2 is 10 mm. Therefore, the width w2 of the second buffer portion 121 has to be at least equal to or greater than 6 mm larger than the width w1 of the first buffer portion 111 such that even when the first separator 110 and the second separator 120 are deformed in response to temperature changes, the first buffer portion 111 and the second buffer portion 121 can absorb such deformation without interfering with each other.

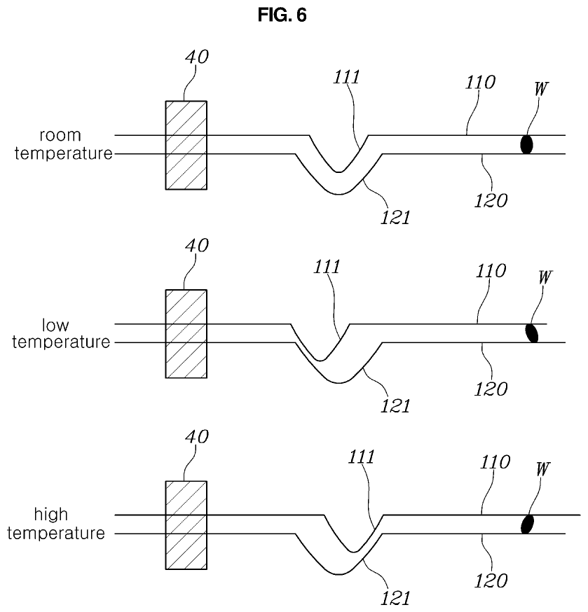

Meanwhile, FIG. 6 is a view showing a behavior of the separator assembly for the fuel cell according to the embodiment of the present disclosure, which is generated during operation of the fuel cell stack. Under a room temperature environment, the first buffer portion 111 of the first separator 110 and the second buffer portion 121 of the second separator 120 are spaced apart from each other at a predetermined interval at locations corresponding to each other.

In this state, when a low temperature environment having a temperature lower than the room temperature is created, the first separator 110 and the second separator 120 contract. The first separator 110 having a relatively larger thermal expansion coefficient is larger in amount of contraction than the second separator 120. Therefore, even when the amount of contraction of the first buffer portion 111 contracted inward of the first separator 110 is larger than the amount of contraction of the second buffer portion 121 in the low temperature environment as shown in FIG. 6, the amount of deformation of the first buffer portion 111 can be absorbed within the area of the depressed second buffer portion 121.

Further, when a high temperature environment having a temperature higher than the room temperature is created, the first separator 110 and the second separator 120 expand. The first separator 110 having a relatively larger thermal expansion coefficient is larger in amount of expansion than the second separator 120. Therefore, even when the amount of expansion of the first buffer portion 111 expanded outward of the first separator 110 is larger than the amount expansion of the second buffer portion 121 in the high temperature environment as shown in FIG. 6, the amount of deformation of the first buffer portion 111 can be absorbed within the area of the depressed second buffer portion 121.

Meanwhile, the first buffer portion and the second buffer portion may be implemented in various shapes.

As shown in FIG. 4, multiple first buffer portions 111 and multiple second buffer portions 121 may be provided in a dot shape. The multiple dot-shaped first buffer portions 111 and the multiple dot-shaped second buffer portions 121 are arranged to be spaced apart from each other at a predetermined interval. Therefore, deformation due to temperature changes can be uniformly absorbed for each region.

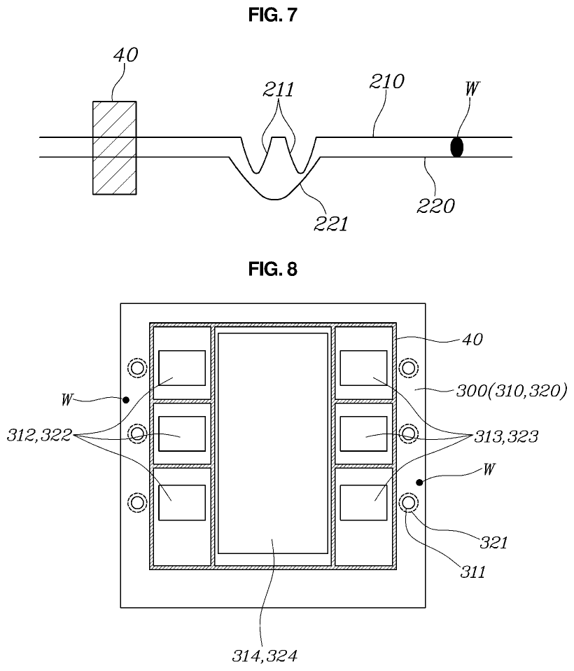

Further, FIG. 7 is a view showing a modification of the separator assembly for the fuel cell according to the embodiment of the present disclosure. As shown in FIG. 7, multiple first buffer portions 211 of a first separator 210 may be provided at a location corresponding to a second buffer portion 221 of a second separator 220. Therefore, it is possible for the first buffer portions 211 to more effectively absorb the amount of deformation of the first separator 210 being relatively larger in amount of deformation in response to temperature changes.

Meanwhile, FIGS. 8 to 10 are views showing a separator assembly for a fuel cell according to other embodiments of the present disclosure.

FIG. 8 is a view showing an example in which a first buffer portion and a second buffer portion are provided in a separator having an aspect ratio of 1:1. As shown in FIG. 8, similar to the above-described embodiment, a separator assembly for a fuel cell according to another embodiment of the present disclosure includes a first separator 310 and a second separator 320. The first separator 310 includes a reaction surface 314 provided in the center thereof in which an MEA is disposed, and multiple inlet manifolds 312 and multiple outlet manifolds 313 that are provided at opposite sides of the reaction surface 314, respectively. In order to seal the reaction surface 314, the inlet manifolds 312, and the outlet manifolds 313, a gasket 40 is used to surround a region where the reaction surface 314, the inlet manifolds 312, and the outlet manifolds 313 are provided.

Further, similar to the first separator 310, the second separator 320 also includes a reaction surface 324, multiple inlet manifolds 322, and multiple outlet manifolds 323, and a gasket 40 is provided.

Further, a welding spot W where the first separator 310 and the second separator 320 are joined together is provided at a predetermined point in each of edge regions of the first separator 310 and the second separator 320. The first separator 310 and the second separator 320 are integrally joined together at the welding spots W.

In particular, the first separator 310 and the second separator 320 has an aspect ratio of 1:1.

The first separator 310 has a first buffer portion 311, and the second separator 320 has a second buffer portion 321. The first buffer portion 311 and the second buffer portion 312 may be provided at locations and shapes corresponding to the locations and shapes of the first buffer portion 111 and the second buffer portion 121 of the above-described embodiment.

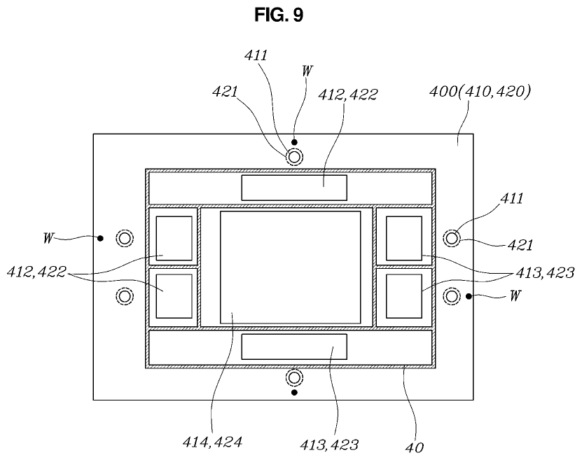

FIG. 9 is a view showing an example in which a first buffer portion and a second buffer portion are provided in a separator in which manifolds are arranged in four directions. As shown in FIG. 9, similar to the above-described embodiments, a separator assembly for a fuel cell according to another embodiment of the present disclosure includes a first separator 410 and a second separator 420. The first separator 410 includes a reaction surface 414 provided at the center thereof in which an MEA is disposed. However, in this embodiment, the first separator 410 has multiple inlet manifolds 412 and multiple outlet manifolds 413 that are provided at four sides of the reaction surface 414 along the periphery thereof. In order to seal the reaction surface 414, the inlet manifolds 412, and the outlet manifolds 413, a gasket 40 is used to surround a region where the reaction surface 414, the inlet manifolds 412, and the outlet manifolds 413 are provided.

Further, similar to the first separator 410, the second separator 420 also includes a reaction surface 424, multiple inlet manifolds 422, and multiple outlet manifolds 423, and a gasket 40 is provided.

Further, a welding spot W where the first separator 410 and the second separator 420 are joined together is provided at a predetermined point in each of edge regions of the first separator 410 and the second separator 420. The first separator 410 and the second separator 420 are integrally joined together at the welding spots W. In consideration of the structure in that the inlet manifolds 412 and 422 and the outlet manifolds 413 and 423 are provided at four sides of the reaction surfaces 414 and 424, a welding spot W is provided at each side of the reaction surfaces 414 and 424.

The first separator 410 has a first buffer portion 411, and the second separator 420 has a second buffer portion 421. The first buffer portion 411 and the second buffer portion 421 are provided between the inlet manifolds 412 and 422 and the outlet manifolds 413 and 423, which are provided at four sides of the reaction surfaces 414 and 424, and the respective welding spots W. The first buffer portion 411 and the second buffer portion 421 may be formed in shapes corresponding to the shapes of the first buffer portion 111 and the second buffer portion 121 of the above-described embodiment, respectively.

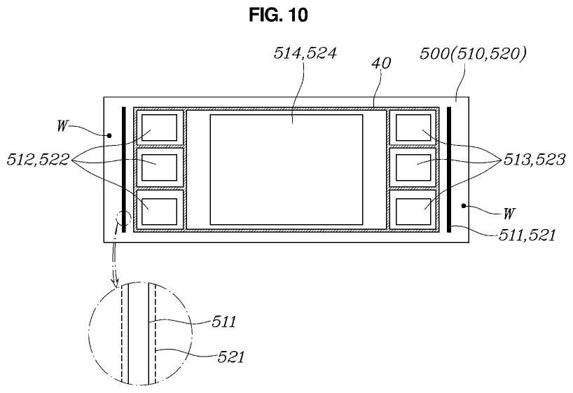

Meanwhile, FIG. 10 is a view showing an example in which a buffer portion is changed in shape. As shown in FIG. 10, similar to the above-described embodiments, a separator assembly for a fuel cell according to another embodiment of the present disclosure includes a first separator 510 and a second separator 520. The first separator 510 includes a reaction surface 514 provided at the center thereof in which an MEA is disposed, and multiple inlet manifolds 512 and multiple outlet manifolds 513 that are provided at opposite sides of the reaction surface 514. In order to seal the reaction surface 514, the inlet manifolds 512, and the outlet manifolds 513, a gasket 40 is used to surround a region where the reaction surface 514, the inlet manifolds 512, and the outlet manifolds 513 are provided.

Further, similar to the first separator 510, the second separator 520 also includes a reaction surface 524, multiple inlet manifolds 522, and multiple outlet manifolds 523, and a gasket 40 is provided.

Further, a welding spot W where the first separator 510 and the second separator 520 are joined together is provided at a predetermined point in each of edge regions of the first separator 510 and the second separator 520. The first separator 510 and the second separator 520 are integrally joined together at the welding spots W.

The first separator 510 has a first buffer portion 511, and the second separator 520 has a second buffer portion 521.

However, in this embodiment, the first buffer portion 511 and the second buffer portion 521 are provided in a line shape. It is preferable that the first buffer portion 511 and the second buffer portion 521 have widths and depths corresponding to the widths and depths of the above-described embodiments.

Meanwhile, the first buffer portion 511 and the second buffer portion 521 provided in a line shape are provided between the multiple inlet manifolds 512 and 522 and an inlet-side welding spot W and between the multiple manifolds 513 and 523 and an outlet-side welding spot W, respectively.

Meanwhile, in the present disclosure, the thicknesses of the first and second separators according to various embodiments are the same. However, the present disclosure is not limited thereto, and the thicknesses of the first and second separators may be different from each other. In this case, the first separator has to be larger in amount of thermal deformation than the second separator.

Although the exemplary embodiments of the present disclosure have been described for illustrative purposes, those skilled in the art will appreciate that various modifications, additions and substitutions are possible, without departing from the scope and spirit of the disclosure as disclosed in the accompanying claims.

What is claimed is:

1. A separator assembly for a fuel cell, the separator assembly being configured such that separators made of metal materials having different thermal expansion coefficients are joined together, the separator assembly comprising:
a first separator including a first buffer portion formed by depressing at least one point on a surface of the first separator; and
a second separator integrated with the first separator by joining, and including a second buffer portion that is formed by depressing a surface of the second separator such that the second buffer portion is spaced apart from the first buffer portion and surrounds the first buffer portion.

2. The separator assembly of claim 1, wherein the first separator has a larger thermal expansion coefficient than the second separator.

3. The separator assembly of claim 1, wherein each of the first separator and the second separator includes multiple manifolds provided at locations corresponding to each other and through which reactive gas and coolant are introduced and discharged,
a welding spot where the first separator and the second separator are welded together is provided at a predetermined point in each of edge regions of the first separator and the second separator, and
each of the first buffer portion and the second buffer portion is provided in a region between the manifolds and the welding spot.

4. The separator assembly of claim 1, wherein a width (w1) of the first buffer portion is smaller than a width (w2) of the second buffer portion.

5. The separator assembly of claim 4, wherein the width (w1) of the first buffer portion and the width (w2) of the second buffer portion satisfies the following equation:
w2−w1>x1−x2,
wherein x1 denotes an amount of expansion of the first separator in response to temperature, and x2 denotes an amount of expansion of the second separator in response to temperature.

6. The separator assembly of claim 1, wherein a depth (h1) of the first buffer portion is smaller than a depth (h2) of the second buffer portion.

7. The separator assembly of claim 1, wherein the first buffer portion and the second buffer portion are provided in a dot shape.

8. The separator assembly of claim 7, wherein the second buffer portion is provided in a shape of one dot, and
the first buffer portion is provided in a shape of at least one dot.

9. The separator assembly of claim 1, wherein the first buffer portion and the second buffer portion are provided in a line shape.

10. A fuel cell stack provided by stacking multiple unit cells in which each of the unit cells includes a membrane electrode assembly, a pair of gas diffusion layers, a first separator, and a second separator, comprising:
the first and second separators facing each other in adjacent unit cells are integrated by joining,
the first separator includes a first buffer portion formed by depressing at least one point on a surface of the first separator, and
the second separator includes a second buffer portion formed by depressing a surface of the second separator such that the second buffer portion is spaced apart from the first buffer portion and surrounds the first buffer portion.
